(19) United States
(12) Patent Application Publication
(10) Pub. No.: US 2021/0281196 A1
(43) Pub. Date: Sep. 9, 2021

(54) AIR CONDITIONER

(71) Applicant: Mitsubishi Electric Corporation, Tokyo (JP)

(72) Inventors: Yuichi SHIMIZU, Tokyo (JP); Kazunori HATAKEYAMA, Tokyo (JP)

(21) Appl. No.: 17/261,265

(22) PCT Filed: Aug. 31, 2018
(86) PCT No.: PCT/JP2018/032294

§ 371 Date: Jan. 19, 2021

(51) Int. Cl. H02P 5/74; F24F 11/88

(52) U.S. Cl. CPC H02P 5/74; F24F 2110/10; F24F 11/88

(57) ABSTRACT

There are provided a single inverter to generate a three-phase alternating-current voltage from a direct-current voltage; n motors connected in series to an output side of the inverter to generate power, n being an integer not less than 2; a moving unit to receive the power to be driven; and a controller to perform sensorless control on the basis of an induced voltage caused by the n motors.

### CROSS REFERENCE TO RELATED APPLICATION

This application is a U.S. national stage application of International Application No. PCT/JP2018/032294 filed on Aug. 31, 2018, the contents of which are incorporated herein by reference.

### TECHNICAL FIELD

The present invention relates to an air conditioner.

### BACKGROUND

To operate a permanent magnet synchronous motor (PMS motor), it is necessary to control currents and voltages on the basis of a magnetic pole position of a rotor of the PMS motor. In some cases, a position detector, such as an encoder or a Hall sensor, is used to detect the magnetic pole position. However, the use of the position detector leads to problems, such as an increase in cost or an increase in the size of the motor.

Thus, for example, Patent Literature 1 discloses a motor drive controller that performs sensorless control that controls a PMS motor by estimating a magnetic pole position of a rotor of the PMS motor. In the sensorless control, a method is widely known that estimates a position of a rotor of a PMS motor by using an induced voltage during rotation caused by the magnetic flux of a permanent magnet of the PMS motor.

### PATENT LITERATURE

Patent Literature 1: Japanese Patent Application Publication No. 2017-135781

In air conditioners, with recent improvement in insulation technology or in heat exchanger performance, when the temperature of a space to be subjected to temperature control stays at a desired value to some extent, a fan or a compressor is operated at low speed, thereby improving the energy efficiency.

However, the conventional sensorless control has a problem in that, at the time of low-speed rotation, at which the induced voltage is low, the accuracy of the position estimation is low, and the PMS motor cannot be operated at low speed.

### SUMMARY

Thus, one or more aspects of the present invention are intended to make it possible to operate a PMS motor at low speed in sensorless control.

An air conditioner according to a first aspect of the present invention includes: a single inverter to generate a three-phase alternating-current voltage from a direct-current voltage; n motors connected in series to an output side of the inverter to generate power, n being an integer not less than 2; a moving unit to receive the power to be driven; and a controller to perform sensorless control on a basis of an induced voltage caused by the n motors.

An air conditioner according to a second aspect of the present invention includes: a single inverter to generate a three-phase alternating-current voltage from a direct-current voltage; two motors to receive the three-phase alternating-current voltage to generate power; a switching unit to switch between a multiple connection in which the two motors are connected in series to an output side of the inverter and a single connection in which only one of the two motors is connected to the output side of the inverter; a moving unit to receive the power to be driven; and a controller to perform sensorless control on a basis of an induced voltage caused by the two motors in the multiple connection and on a basis of an induced voltage caused by the one motor in the single connection.

An air conditioner according to a third aspect of the present invention includes: a single inverter to generate a three-phase alternating-current voltage from a direct-current voltage; n motors to receive the three-phase alternating-current voltage to generate power, n being an integer not less than 2; a switching unit to switch between a series connection in which the n motors are connected in series to an output side of the inverter and a parallel connection in which the n motors are connected in parallel to the output side of the inverter; a moving unit to receive the power to be driven; and a controller to perform sensorless control on a basis of an induced voltage caused by the n motors.

According to one or more aspects of the present invention, it is possible to operate a PMS motor at low speed in sensorless control.

### BRIEF DESCRIPTION OF DRAWINGS

FIG. 1 is a schematic diagram illustrating PMS motors and a motor driver used in an air conditioner according to a first embodiment.

FIG. 2 is a functional block diagram schematically illustrating a configuration of a part of a controller that performs sensorless control.

FIGS. 3A and 3B are schematic diagrams for explaining an example of processing in a voltage command generator.

FIGS. 4A to 4C are schematic diagrams for explaining an example of processing in a PWM signal generator.

FIG. 5 is a schematic diagram illustrating a configuration of the air conditioner according to the first embodiment.

FIG. 6 is a schematic diagram illustrating motors and a motor driver used in an air conditioner according to a second embodiment.

FIG. 7 is a schematic diagram illustrating a configuration of the air conditioner according to the second embodiment.

FIG. 8 is a schematic diagram illustrating a modification of the air conditioner according to the second embodiment.

FIG. 9 is a schematic diagram for explaining switches in the modification of the air conditioner according to the second embodiment.

FIG. 10 is a schematic diagram illustrating motors and a motor driver used in an air conditioner according to a third embodiment.

FIG. 11 is a schematic diagram illustrating a configuration of the air conditioner according to the third embodiment.

### DESCRIPTION OF EMBODIMENTS

Air conditioners according to embodiments will be described below with reference to the attached drawings. The present invention is not limited by the embodiments described below.

### First Embodiment

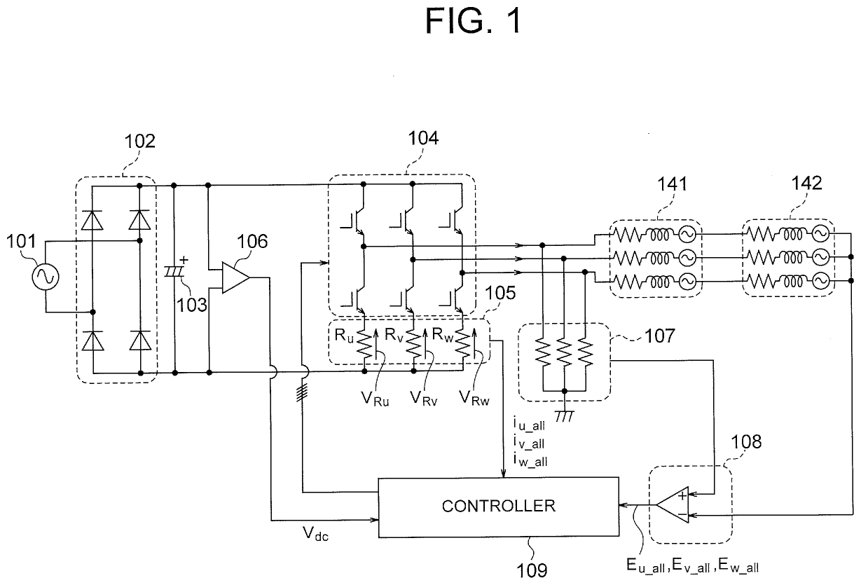

FIG. 1 is a schematic diagram illustrating PMS motors and a motor driver used in an air conditioner according to a first embodiment. The motor driver is for driving a first PMS motor 141 and a second PMS motor 142. Hereinafter, PMS motors may be referred to simply as motors.

The illustrated motor driver includes a rectifier 102, a smoothing device 103, an inverter 104, an inverter current detector 105, an input voltage detector 106, an induced voltage detector 107, a differential amplifier 108, and a controller 109.

The rectifier 102 rectifies an alternating-current (AC) voltage from an AC power supply 101 to generate a direct-current (DC) voltage.

The smoothing device 103, which is formed by a capacitor or the like, smooths the DC voltage from the rectifier 102 and supplies it to the inverter 104.

The AC power supply 101 is single-phase in the example of FIG. 1, but may be a three-phase power supply. When the AC power supply 101 is three-phase, a three-phase rectifier is used as the rectifier 102.

As the capacitor of the smoothing device 103, an aluminum electrolytic capacitor, which has large capacitance, is often used in general, but a film capacitor, which is long-life, may be used. A small-capacity capacitor may be used to reduce harmonics of a current flowing through the AC power supply 101.

Also, a reactor (not illustrated) may be inserted between the AC power supply 101 and the smoothing device 103, in order to reduce harmonic currents or improve the power factor.

The inverter 104 generates a three-phase AC voltage of variable frequency and variable voltage value from the DC voltage smoothed by the smoothing device 103. The first motor 141 and second motor 142 are connected in series to an output side of the inverter 104.

As semiconductor switching elements constituting the inverter 104, insulated gate bipolar transistors (IGBTs) or metal oxide semiconductor field effect transistors (MOSFETs) are often used.

To reduce surge voltages due to switching of the semiconductor switching elements, freewheeling diodes (not illustrated) may be connected in parallel with the semiconductor switching elements. Parasitic diodes of the semiconductor switching elements may be used as the freewheeling diodes. In the case of MOSFETs, it is possible to provide functions similar to those of the freewheeling diodes by turning on the MOSFETs at the time of back-flow.

The material forming the semiconductor switching elements is not limited to silicon (Si), but may be wide-bandgap semiconductor, such as silicon carbide (SiC), gallium nitride (GaN), gallium oxide (Ga₂O₃), or diamond. By using wide-bandgap semiconductor, it is possible to reduce the power loss and increase the switching speed.

The inverter current detector 105 detects currents flowing through the inverter 104. In the illustrated example, the inverter current detector 105 determines currents (inverter currents) i_{u_all}, i_{v_all}, and i_{w_all} of the respective phases of the inverter 104, on the basis of the voltages V_{Ru}, V_{Rv}, and V_{Rw} across resistors Rᵤ, Rᵥ, and R_{w} connected in series with respective switching elements of three lower arms of the inverter 104.

The input voltage detector 106 detects an input voltage (DC bus voltage) V_{dc} of the inverter 104.

The induced voltage detector 107 detects combined induced voltages that are combinations of induced voltages caused by the first motor 141 and second motor 142.

The differential amplifier 108 detects potential differences between the combined induced voltages detected by the induced voltage detector 107 and a neutral point of motor windings.

The controller 109 outputs signals for operating the inverter 104 on the basis of the current values detected by the inverter current detector 105, the voltage value detected by the input voltage detector 106, and the potential differences detected by the differential amplifier 108. For example, the controller 109 performs sensorless control on the basis of the induced voltages caused by the first motor 141 and second motor 142. Specifically, the controller 109 estimates a magnetic pole position of a rotor (not illustrated) of the first motor 141 or second motor 142 on the basis of the induced voltages caused by the first motor 141 and second motor 142, and controls the first motor 141 and second motor 142 through the inverter 104.

In the above-described example, the inverter current detector 105 detects the currents of the respective phases of the inverter 104 by means of the three resistors Rᵤ, Rᵥ, and R_{w} connected in series with the switching elements of the lower arms of the inverter 104. Alternatively, it may detect the currents of the respective phases of the inverter 104 by means of a resistor (not illustrated) connected between a common junction of the switching elements of the lower arms and a negative electrode of the capacitor as the smoothing device 103.

It is also possible to provide a current detector (not illustrated) between the inverter 104 and the first motor 141 and detect the currents of the respective phases of the inverter 104 by means of the current detector.

It is also possible to provide a current detector (not illustrated) between the first motor 141 and the second motor 142 and detect the currents of the respective phases of the inverter 104 by means of the current detector.

For the detection of the currents, it is possible to use current transformers, Hall elements, or the like, instead of the configuration in which each current is calculated from the voltage across a resistor.

The controller 109 can be implemented by processing circuitry. The processing circuitry may be implemented by dedicated hardware using analog circuitry, digital circuitry, or the like, may be implemented by software, and may be implemented by a combination of hardware and software. When implemented by software, the controller 109 is formed by a microcomputer including a central processing unit (CPU), a digital signal processor (DSP), or the like.

As the differential amplifier 108, circuitry embedded in a microcomputer or the like forming the controller 109 may be used. Although FIG. 1 illustrates only the one differential amplifier 108 for simplicity, three differential amplifiers are actually provided to detect the combined induced voltages of the three phases of the motors 141 and 142.

Also, although in FIG. 1 the potential differences detected by the differential amplifier 108 are input to the controller 109, the combined induced voltages detected by the induced voltage detector 107 may be input to the controller 109, for example. In such a case, the differential amplifier 108 need not be provided.

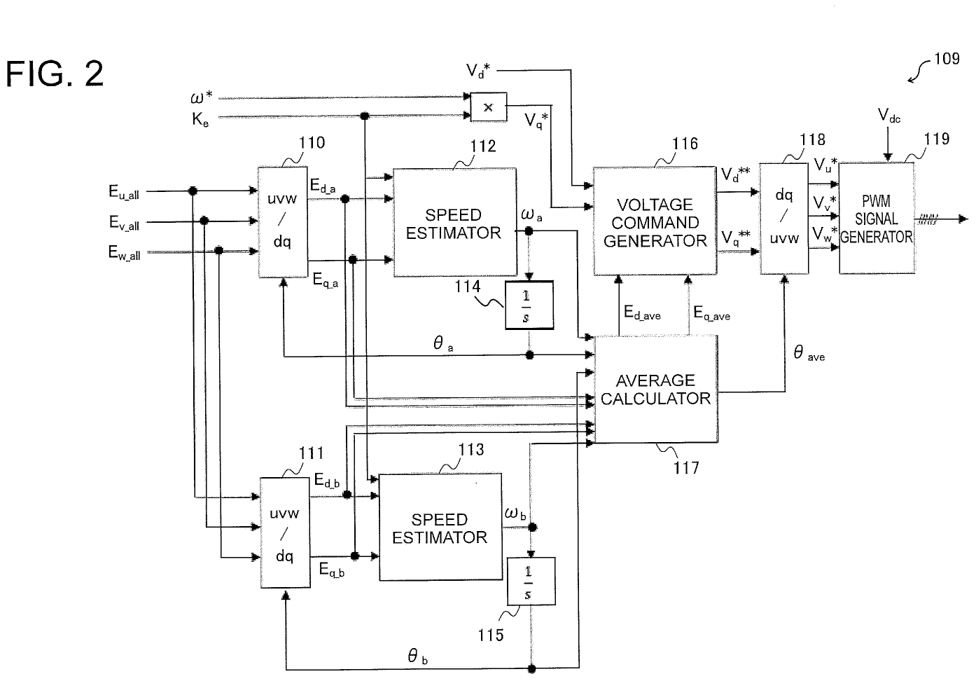

FIG. 2 is a functional block diagram schematically illustrating a configuration of a part of the controller 109 that performs the sensorless control.

As illustrated, the part of the controller 109 that performs the sensorless control includes coordinate converters 110 and 111, speed estimators 112 and 113, integrators 114 and 115, a voltage command generator 116, an average calculator 117, a coordinate converter 118, and a PWM signal generator 119.

The coordinate converter 110 performs coordinate conversion of the potential differences E_{u_all}, E_{v_all}, and E_{w_all} from the differential amplifier 108 from a stationary three-phase coordinate system to a rotational two-phase coordinate system by using a phase estimated value (magnetic pole position estimated value) θₐ of the first motor 141, thereby determining induced voltages E_{d_a} and E_{q_a} in d- and q-axes of the first motor 141.

The coordinate converter 111 performs coordinate conversion of the potential differences E_{u_all}, E_{v_all}, and E_{w_all} from the differential amplifier 108 from a stationary three-phase coordinate system to a rotational two-phase coordinate system by using a phase estimated value (magnetic pole position estimated value) θ_{b} of the second motor 142, thereby determining induced voltages E_{d_b} and E_{q-b} in d- and q-axes of the second motor 142.

The speed estimator 112 determines a rotational frequency estimated value ωₐ of the first motor 141 on the basis of the induced voltages E_{d_a} and E_{q_a} in the d- and q-axes of the first motor 141 and a proportionality factor Kₑ with the rotational frequency.

Similarly, the speed estimator 113 determines a rotational frequency estimated value ω_{b} of the second motor 142 on the basis of the induced voltages E_{d_b} and E_{q_b} in the d- and q-axes of the second motor 142 and the proportionality factor Kₑ.

For the method of estimating the rotational frequencies, it is possible to use the fact that the magnitudes of the induced voltages of the motors and the rotational frequencies are in proportional relationship, for example. Specifically, the rotational frequencies can be approximately estimated by previously storing, in the controller 109, the proportionality factor Kₑ (referred to below as the induced voltage constant) between the induced voltages of the motors and the rotational frequencies and dividing each of the induced voltages E_{q_a} and E_{q_b} on the q-axes of the respective motors 141 and 142 by the induced voltage constant Kₑ.

Here, when the n motors connected in series have the same specifications, the magnitude of the induced voltage constant Kₑ may be determined by Kₑ=K_{e_m}×n. The value K_{e_m} is an induced voltage constant between the induced voltage per one motor and the rotational frequency.

The method of estimating the rotational frequencies may be any method capable of estimating the rotational frequencies or phases. Also, regarding the information used for the calculation, as long as the rotational frequencies or phases can be estimated, the information described here may be omitted, and information other than the information described here may be used.

The integrator 114 integrates the rotational frequency estimated value ωₐ of the first motor 141, thereby determining the phase estimated value θₐ of the first motor 141.

Similarly, the integrator 115 integrates the rotational frequency estimated value ω_{b} of the second motor 142, thereby determining the phase estimated value θ_{b} of the second motor 142.

Then, output voltage command values are determined. For example, an output voltage command value V_{q}* for the q-axes of the motors 141 and 142 is set to a value obtained by multiplying a target rotational frequency ω* by the induced voltage constant Kₑ, and an output voltage command value V_{d}* for the d-axes is set to zero.

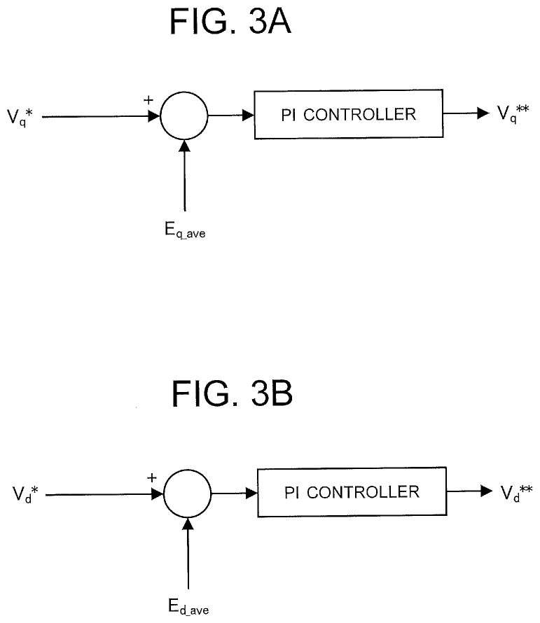

The voltage command generator 116 performs PI control so that a difference between the q-axis output voltage command value V_{q}* and an average E_{q_ave} of the q-axis induced voltage E_{q_a} of the first motor 141 and the q-axis induced voltage E_{q_b} of the second motor 142 is zero, thereby determining a q-axis voltage command value V_{q}**, as illustrated in FIG. 3A.

Similarly, the voltage command generator 116 performs PI control so that a difference between the d-axis output voltage command value V_{d}* and an average E_{d_ave} of the d-axis induced voltage E_{d_a} of the first motor 141 and the d-axis induced voltage E_{d_b} of the second motor 142 is zero, thereby determining a d-axis voltage command value V_{d}**, as illustrated in FIG. 3B.

The average calculator 117 calculates the average E_{q_ave} of the q-axis induced voltage E_{q_a} of the first motor 141 and the q-axis induced voltage E_{q_b} of the second motor 142 and the average E_{d_ave} of the d-axis induced voltage E_{d_a} of the first motor 141 and the d-axis induced voltage E_{d_b} of the second motor 142.

The average calculator 117 also calculates an average phase θₐᵥₑ that is an average of the phase estimated value θₐ of the first motor 141 and the phase estimated value θ_{b} of the second motor 142.

The coordinate converter 118 performs coordinate conversion of the d-axis voltage command value V_{d}** and q-axis voltage command value V_{q}** from the rotational two-phase coordinate system to a stationary three-phase coordinate system on the basis of the average phase θₐᵥₑ, thereby determining voltage command values vᵤ*, vᵥ*, and v_{w}* in the stationary three-phase coordinate system.

For example, the coordinate converter 118 determines an applied voltage phase θᵥ from the average phase θₐᵥₑ and the d- and q-axis voltage command values v_{d}* and v_{q}*, and performs coordinate conversion of the d-axis voltage command value V_{d}** and q-axis voltage command value V_{q}** from the rotational two-phase coordinate system to the stationary three-phase coordinate system on the basis of the applied voltage phase θᵥ, thereby determining the voltage command values vᵤ*, vᵥ*, and v_{w}* in the stationary three-phase coordinate system.

For example, the applied voltage phase θᵥ can be obtained by adding a leading phase angle θ_{f} to the average phase θₐᵥₑ, the leading phase angle θ_{f} being obtained from the d- and q-axis voltage command values v_{d}* and v_{q}* by e_{f}=tan⁻¹(v_{q}*/v_{d}*)

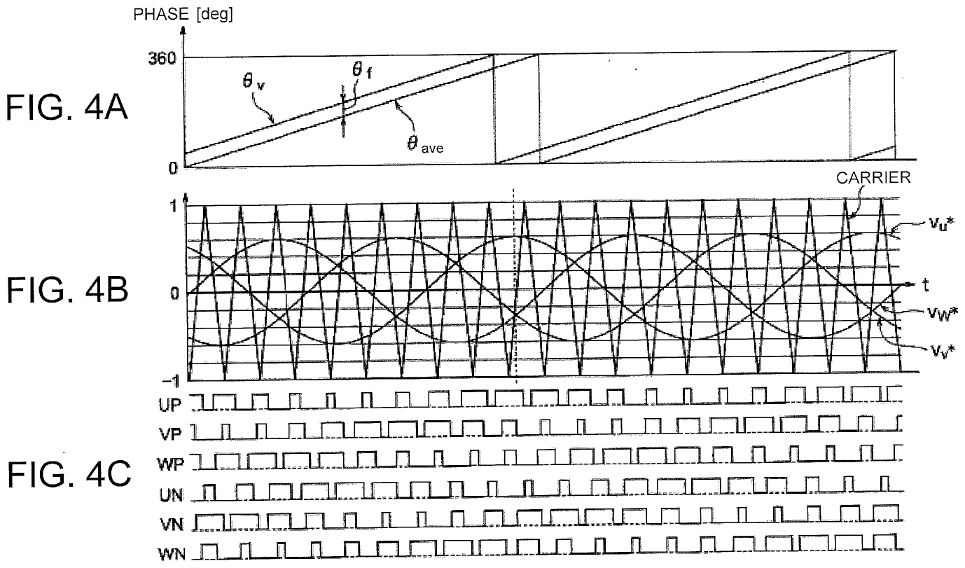

FIG. 4A illustrates an example of the average phase θₐᵥₑ, leading phase angle θ_{f}, and applied voltage phase θᵥ, and FIG. 4B illustrates an example of the voltage command values vᵤ*, vᵥ*, and v_{w}* determined by the coordinate converter 118.

The PWM signal generator 119 generates PWM signals UP, VP, WP, UN, VN, and WN illustrated in FIG. 4C from the input voltage V_{dc} and voltage command values vᵤ*, vᵥ*, and v_{w}*. The PWM signals UP, VP, WP, UN, VN, and WN are supplied to the inverter 104 and used for control of the switching elements.

In the inverter 104, by controlling turning on and off of the switching elements of the inverter 104 on the basis of the PWM signals UP, VP, WP, UN, VN, and WN, AC voltages of variable frequency and variable voltage value can be outputted from the inverter 104 and applied to the first motor 141 and second motor 142.

In FIG. 4B, the voltage command values vᵤ*, vᵥ*, and v_{w}* are described as sine waves, but may be ones with a third harmonic wave superimposed, and may be of any form as long as they can drive the first motor 141 and second motor 142.

Here, since the n (n being an integer not less than 2) PMS motors are controlled in series as described above, a sum of the induced voltages of the respective PMS motors acting on the inverter is n times that when one PMS motor is operated. In general, in a case where a PMS motor is operated by sensorless control, when the motor induced voltage is small, the times during which the switching elements of the inverter are turned on are short, which decreases the current detection accuracy and position estimation accuracy of the PMS motor.

In this embodiment, by connecting multiple PMS motors in series, it is possible to increase the magnitude of the induced voltage by n times. Thus, in this embodiment, it is possible to decrease the minimum rotational frequency by up to about 1/n times compared to a conventional case in which one PMS motor is operated.

In this embodiment, since the two motors 141 and 142 are connected in series to the inverter 104 as illustrated in FIG. 1, it is possible to decrease the minimum rotational frequency by up to ½ times compared to a case in which one motor is connected to the inverter. Thus, the controller 109 can operate the two motors 141 and 142 connected in series at a rotational frequency lower than a minimum rotational frequency that is a lowest rotational frequency at which one motor (e.g., the motor 141) can be rotated for a predetermined time period. The predetermined time period is a certain time period having a certain amount of length, excluding time periods, such as a time of starting or stopping operation of the motors, in which the rotational frequencies of the motors 141 and 142 are temporarily low. Thus, the predetermined time period may be defined to have an arbitrary length that can exclude instantaneous time periods.

When one PMS motor is operated by sensorless control, the minimum rotational frequency is about one tenth of the maximum rotational frequency at which the PMS motor can be operated, the maximum rotational frequency being determined from the bus voltage of the inverter and the induced voltage constant of the PMS motor. Thus, by connecting n PMS motors in series, it is possible to decrease the minimum rotational frequency to a rotational frequency of about one (10×n)th of the maximum rotational frequency.

Thus, when the maximum rotational frequency at which the PMS motor can be operated is denoted by R_{H}, in this embodiment, by connecting n PMS motors in series, it is possible to operate the n PMS motors at a rotational frequency R that is lower than the minimum rotational frequency when one PMS motor is operated by sensorless control and that is within the range of R_{H}×1/(10×n)≤R<R_{H}×1/10.

A case in which the motors 141 and 142 and the motor driver illustrated in FIG. 1 are applied to fans of an air conditioner will now be described.

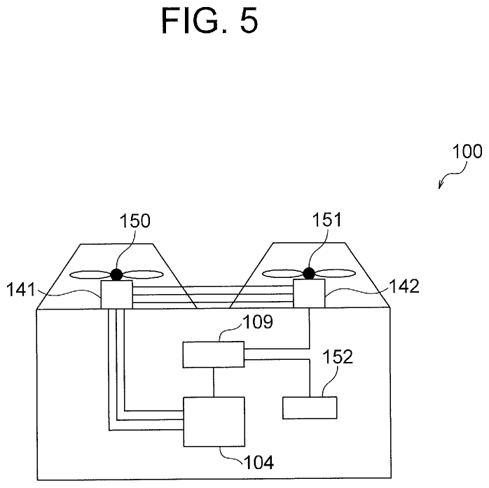

FIG. 5 is a schematic diagram illustrating a configuration of an air conditioner 100 according to the first embodiment.

The air conditioner 100 includes the inverter 104, the controller 109, the motors 141 and 142, fans 150 and 151, and a sensor 152.

As illustrated in FIG. 5, the two motors 141 and 142 are connected to the single inverter 104. The fan 150 is connected to the motor 141, and the fan 151 is connected to the motor 142. In other words, the fans 150 and 151 are moving units that receive power from the motors 141 and 142 to be driven. The motors 141 and 142 generate power.

The sensor 152 detects a physical quantity indicating at least one of an amount of human activity, an indoor temperature, and an outdoor temperature. For example, the sensor 152 can be implemented by a camera, an infrared sensor, a temperature sensor, or the like.

When the physical quantity, such as the amount of human activity, the indoor temperature, or the outdoor temperature, detected by the sensor 152 is within a predetermined range and there is no need to rapidly change the indoor temperature, the controller 109 operates the motors 141 and 142 at low speed, thereby operating the fans 150 and 151 at an extremely low speed. This can improve the energy efficiency or reduce the noise of the fans 150 and 151, providing a more comfortable space.

It is preferable that the extremely low speed here be lower than one tenth of a maximum rotational frequency at which one motor can be operated, and the extremely low speed be a rotational frequency not lower than one (n×10)th of the maximum rotational frequency. In FIG. 1, n=2.

As above, with the air conditioner 100 according to the first embodiment, in sensorless control, it is possible to operate the PMS motors 141 and 142 at low speed, i.e., to operate them at lower rotational frequencies compared to a case in which one PMS motor is connected.

With the air conditioner 100 according to the first embodiment, when the physical quantity detected by the sensor is within the predetermined range, it is possible to operate the motors 141 and 142 at very low rotational frequency.

The physical quantity here is at least one of an amount of human activity, an indoor temperature, and an outdoor temperature. This makes it possible for the air conditioner 100 according to the first embodiment to provide a comfortable space.

### Second Embodiment

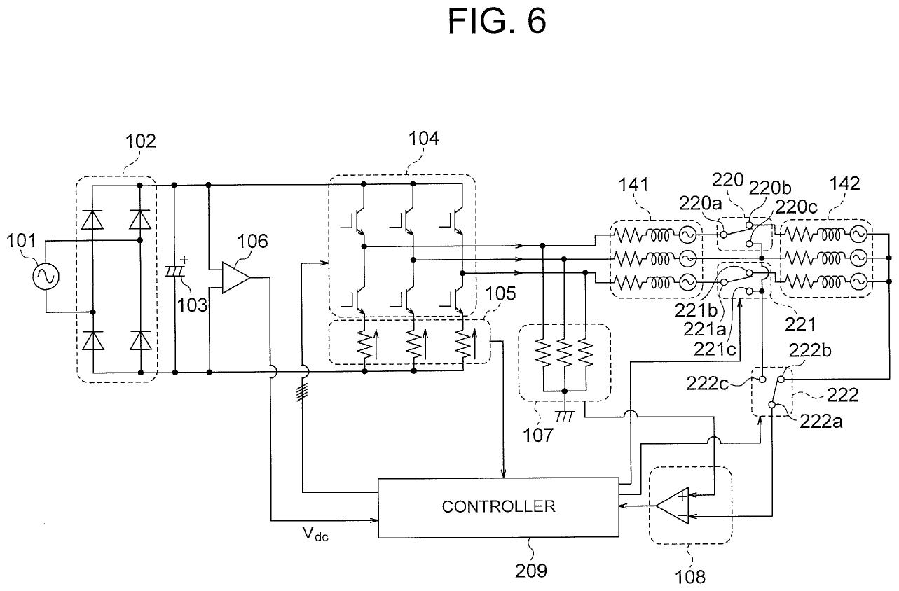

FIG. 6 is a schematic diagram illustrating motors and a motor driver used in an air conditioner according to a second embodiment.

The illustrated motor driver includes a rectifier 102, a smoothing device 103, an inverter 104, an inverter current detector 105, an input voltage detector 106, an induced voltage detector 107, a differential amplifier 108, a controller 209, and switches 220, 221, and 222.

The motor driver of the second embodiment differs from the motor driver of the first embodiment in the controller 209 and switches 220, 221, and 222.

As illustrated in FIG. 6, in the second embodiment, the switches 220 and 221 are provided between a first motor 141 and a second motor 142.

Also, in the second embodiment, the switch 222 is provided to switch an input to the differential amplifier 108 between a rear stage of the first motor 141 and a rear stage of the second motor 142.

In a case where multiple motors are connected in series, when a failure due to, e.g., wire breakage occurs in one of the motors, the current path is not formed, and all the motors stop. Thus, in the second embodiment, the switches 220, 221, and 222 are provided to switch the connection between the motors 141 and 142.

The switch 220 has a first terminal 220a, a second terminal 220b, and a third terminal 220c. The first terminal 220a is connected to a u-phase output line of the first motor 141. The second terminal 220b is connected to a u-phase input line of the second motor 142. The third terminal 220c is connected to the switch 222.

The switch 220 can switch the connection with the first terminal 220a between the second terminal 220b and the third terminal 220c in accordance with a command from the controller 209.

Similarly, the switch 221 has a first terminal 221a, a second terminal 221b, and a third terminal 221c. The first terminal 221a is connected to a w-phase output line of the first motor 141. The second terminal 221b is connected to a w-phase input line of the second motor 142. The third terminal 221c is connected to the switch 222.

The switch 221 can switch the connection with the first terminal 221a between the second terminal 221b and the third terminal 221c in accordance with a command from the controller 209.

The switch 222 has a first terminal 222a, a second terminal 222b, and a third terminal 222c. The first terminal 222a is connected to an input line to the differential amplifier 108. The second terminal 222b is connected to an output line of the second motor 142. The third terminal 222c is connected to the third terminals 220c and 221c of the switches 220 and 221.

The switch 222 can switch the connection with the first terminal 222a between the second terminal 222b and the third terminal 222c in accordance with a command from the controller 209.

In the second embodiment, the first motor 141 and second motor 142 can be connected in series by connecting the first terminals 220a and 221a of the switches 220 and 221 to the second terminals 220b and 221b and connecting the first terminal 222a of the switch 222 to the second terminal 222b.

In this state, for example, when current stops flowing through the motors 141 and 142 due to wire breakage in the second motor 142, the controller 209 detects wire breakage from the current values detected by the inverter current detector 105.

Upon detecting wire breakage, the controller 209 can disconnect the second motor 142 from the inverter 104 by connecting the first terminals 220a and 221a of the switches 220 and 221 to the third terminals 220c and 221c and connecting the first terminal 222a of the switch 222 to the third terminal 222c by commanding the switches 220, 221, and 222, and operate only the first motor 141.

At this time, the controller 209 changes the value of the induced voltage constant Kₑ in accordance with the change in the number of motors operated among the motors 141 and 142. For example, when the number of motors operated is changed from two to one, the value of the induced voltage constant Kₑ is halved as shown by the above equation.

A case in which the motors 141 and 142 and the motor driver illustrated in FIG. 6 are applied to fans of an air conditioner will now be described.

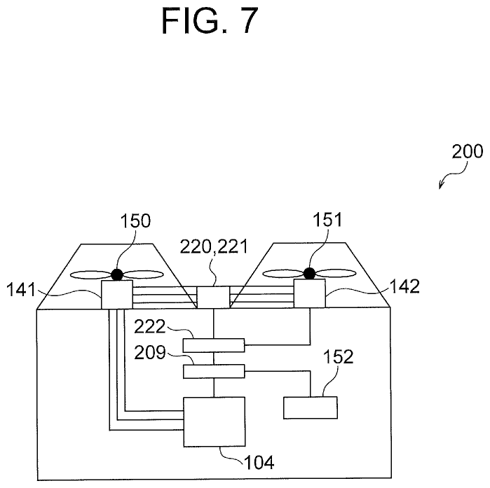

FIG. 7 is a schematic diagram illustrating a configuration of an air conditioner 200 according to the second embodiment.

The air conditioner 200 includes the inverter 104, the controller 209, the motors 141 and 142, fans 150 and 151, a sensor 152, and the switches 220, 221, and 222.

As illustrated in FIG. 7, the controller 209 can switch between a state in which the two motors 141 and 142 are connected to an output side of the single inverter 104 and a state in which the single motor 141 is connected to the output side of the single inverter 104, by controlling the switches 220, 221, and 222. In other words, the switches 220, 221, and 222 function as a switching unit that switches between a multiple connection in which the multiple motors 141 and 142 are connected to the output side of the inverter 104 and a single connection in which the single motor 141 is connected to the output side of the inverter 104. For example, when the motor 142 is not energized, the switches 220, 221, and 222 select the single connection in which the single motor 141 is connected.

By installing wiring as in FIG. 7, it is possible to prevent wiring from being wastefully installed and reduce degradation of efficiency of the motors 141 and 142 or increase of noise compared to a case in which the switches 220, 221, and 222 are provided on a board side.

With the second embodiment, even when the second motor 142 fails, it is possible to operate only the first motor 141 and maintain the function of the air conditioner 200. Thus, when the fan 151 fails, it is possible to perform the operation, extending the life.

In the second embodiment, it is possible to disconnect the second motor 142 and operate only the first motor 141. However, a modification may be made by changing the switches 220, 221, and 222 so that it is possible to operate only the second motor 142.

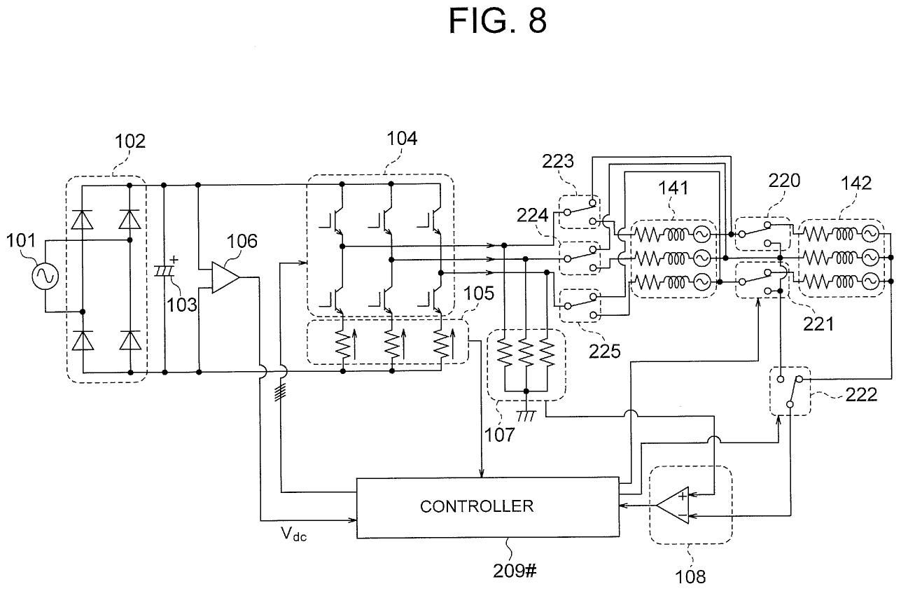

Also, for example, as illustrated in FIG. 8, a modification may be made by providing switches 223, 224, and 225 between the inverter 104 and the first motor 141 so that a controller 209# can operate only one of the first motor 141 and second motor 142 by controlling the switches 223, 224, and 225.

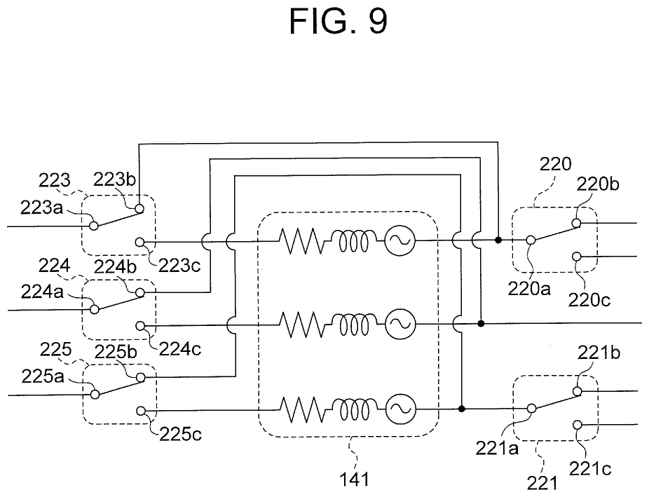

Specifically, as illustrated in FIG. 9, the switch 223 has a first terminal 223a, a second terminal 223b, and a third terminal 223c. The first terminal 223a is connected to a u-phase output line of the inverter 104. The second terminal 223b is connected to the first terminal 220a of the switch 220. The third terminal 223c is connected to a u-phase input line of the first motor 141.

The switch 223 can switch the connection with the first terminal 223a between the second terminal 223b and the third terminal 223c in accordance with a command from the controller 209#.

Similarly, the switch 224 has a first terminal 224a, a second terminal 224b, and a third terminal 224c. The first terminal 224a is connected to a v-phase output line of the inverter 104. The second terminal 224b is connected to a v-phase input line of the second motor 142. The third terminal 224c is connected to a v-phase input line of the first motor 141.

The switch 224 can switch the connection with the first terminal 224a between the second terminal 224b and the third terminal 224c in accordance with a command from the controller 209#.

The switch 225 has a first terminal 225a, a second terminal 225b, and a third terminal 225c. The first terminal 225a is connected to a w-phase output line of the inverter 104. The second terminal 225b is connected to the first terminal 221a of the switch 221. The third terminal 225c is connected to a w-phase input line of the first motor 141.

The switch 225 can switch the connection with the first terminal 225a between the second terminal 225b and the third terminal 225c in accordance with a command from the controller 209#.

In this modification, it is possible to connect the first motor 141 and second motor 142 in series by connecting the first terminals 223a, 224a, and 225a of the switches 223, 224, and 225 to the third terminals 223c, 224c, and 225c, connecting the first terminals 220a and 221a of the switches 220 and 221 to the second terminals 220b and 221b, and connecting the first terminal 222a of the switch 222 to the second terminal 222b.

Also, it is possible to cause only the second motor 142 to operate alone by connecting the first terminals 223a, 224a, and 225a of the switches 223, 224, and 225 to the second terminals 223b, 224b, and 225b, connecting the first terminals 220a and 221a of the switches 220 and 221 to the second terminals 220b and 221b, and connecting the first terminal 222a of the switch 222 to the second terminal 222b.

Further, it is possible to cause only the first motor 141 to operate alone by connecting the first terminals 223a, 224a, and 225a of the switches 223, 224, and 225 to the third terminals 223c, 224c, and 225c, connecting the first terminals 220a and 221a of the switches 220 and 221 to the third terminals 220c and 221c, and connecting the first terminal 222a of the switch 222 to the third terminal 222c.

In other words, the switches 220, 221, 222, 223, 224, and 225 function as a switching unit that switches between a multiple connection in which the multiple motors 141 and 142 are connected in series to the output side of the inverter 104 and a single connection in which the motor 141 or 142 is connected to the output side of the inverter 104.

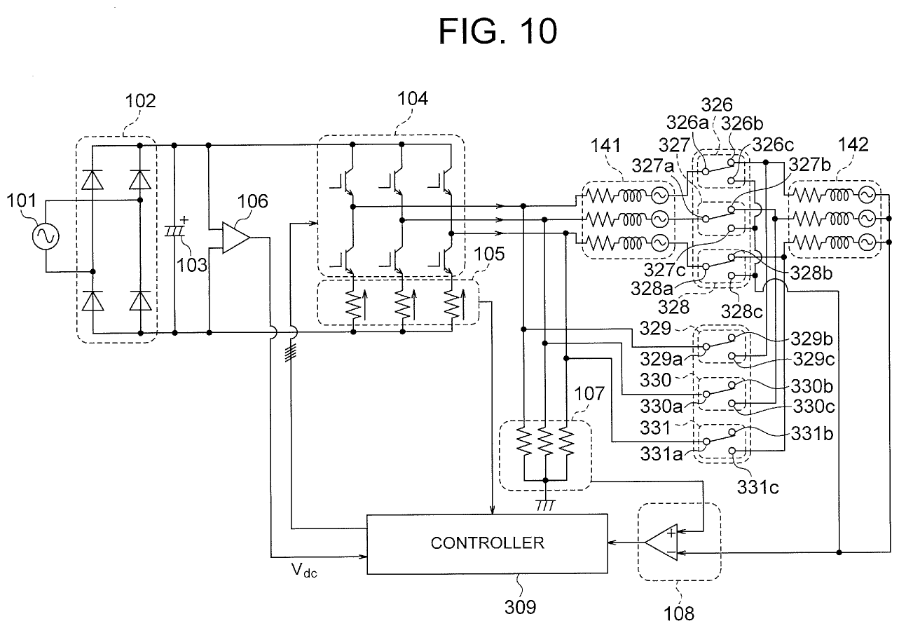

### Third Embodiment FIG. 10 is a schematic diagram illustrating motors and a motor driver used in an air conditioner according to a third embodiment.

The illustrated motor driver includes a rectifier 102, a smoothing device 103, an inverter 104, an inverter current detector 105, an input voltage detector 106, an induced voltage detector 107, a differential amplifier 108, a controller 309, and switches 326, 327, 328, 329, 330, and 331.

The motor driver of the second embodiment differs from the motor driver of the first embodiment in the controller 309 and switches 326, 327, 328, 329, 330, and 331.

The switch 326 has a first terminal 326a, a second terminal 326b, and a third terminal 326c.

The first terminal 326a is connected to a u-phase output line of a first motor 141, the second terminal 326b is connected to a u-phase input line of a second motor 142, and the third terminal 326c is connected to an output line of the second motor 142.

The switch 326 switches the connection of the first terminal 326a between the second terminal 326b and the third terminal 326c in accordance with a command from the controller 309.

The switch 327 has a first terminal 327a, a second terminal 327b, and a third terminal 327c.

The first terminal 327a is connected to a v-phase output line of the first motor 141, the second terminal 327b is connected to a v-phase input line of the second motor 142, and the third terminal 327c is connected to the output line of the second motor 142.

The switch 327 switches the connection of the first terminal 327a between the second terminal 327b and the third terminal 327c in accordance with a command from the controller 309.

The switch 328 has a first terminal 328a, a second terminal 328b, and a third terminal 328c.

The first terminal 328a is connected to a w-phase output line of the first motor 141, the second terminal 328b is connected to a w-phase input line of the second motor 142, and the third terminal 328c is connected to the output line of the second motor 142.

The switch 328 switches the connection of the first terminal 328a between the second terminal 328b and the third terminal 328c in accordance with a command from the controller 309.

The switch 329 has a first terminal 329a, a second terminal 329b, and a third terminal 329c.

The first terminal 329a is connected to a u-phase output line of the inverter 104, the second terminal 329b is not connected to any line and is open, and the third terminal 329c is connected to the u-phase input line of the second motor 142.

The switch 329 switches the connection of the first terminal 329a between the second terminal 329b and the third terminal 329c in accordance with a command from the controller 309.

The switch 330 has a first terminal 330a, a second terminal 330b, and a third terminal 330c.

The first terminal 330a is connected to a v-phase output line of the inverter 104, the second terminal 330b is not connected to any line and is open, and the third terminal 330c is connected to the v-phase input line of the second motor 142.

The switch 330 switches the connection of the first terminal 330a between the second terminal 330b and the third terminal 330c in accordance with a command from the controller 309.

The switch 331 has a first terminal 331a, a second terminal 331b, and a third terminal 331c.

The first terminal 331a is connected to a w-phase output line of the inverter 104, the second terminal 331b is not connected to any line and is open, and the third terminal 331c is connected to the w-phase input line of the second motor 142.

The switch 331 switches the connection of the first terminal 331a between the second terminal 331b and the third terminal 331c in accordance with a command from the controller 309.

In the above configuration, when the first terminals 326a to 331a of the switches 326 to 331 are connected to the second terminals 326b to 331b, the first motor 141 and second motor 142 are connected in series. On the other hand, when the first terminals 326a to 331a of the switches 326 to 331 are connected to the third terminals 326c to 331c, the first motor 141 and second motor 142 are connected in parallel.

The controller 309 changes the value of the induced voltage constant Kₑ in accordance with the switching of the connection manner of the motors 141 and 142. When the n motors are connected in series, the value of the induced voltage constant Kₑ may be determined by Kₑ=K_{e_m}×n, and when the n motors are connected in parallel, the value of the induced voltage constant Kₑ may be determined by Kₑ=K_{e_m}.

In the example of FIG. 10, since the two motors 141 and 142 are used, in the case of the series connection, the value of the induced voltage constant Kₑ is K_{e_m}×2, and in the case of the parallel connection, the value of the induced voltage constant Kₑ is K_{e_m}.

In general, when motors are connected in series and operated, since the induced voltage of the motors increases in proportion to the number of the operated motors, a maximum rotational frequency at which the operation is possible decreases. The maximum rotational frequency at which the operation is possible can be increased by boosting the bus voltage of the inverter. However, this leads to a problem in that the boosting circuit increases the cost or that the control is complicated.

With the third embodiment, when it is desired to increase the rotational frequency of the motors, it is possible to increase the maximum rotational frequency of the motors to a level equal to that when only one motor is operated, by switching to the parallel connection.

A case in which the motors 141 and 142 and the motor driver illustrated in FIG. 10 are applied to fans of an air conditioner will now be described.

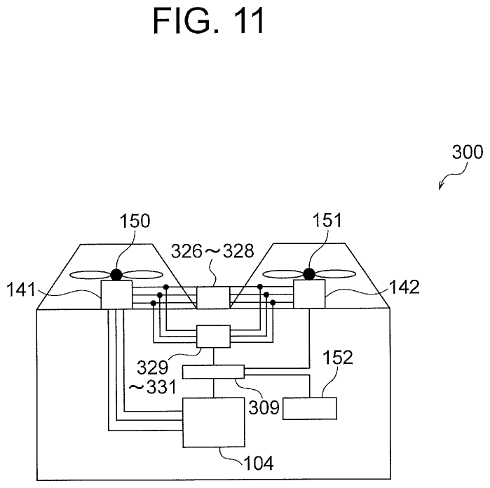

FIG. 11 is a schematic diagram illustrating a configuration of an air conditioner 300 according to the third embodiment.

The air conditioner 300 includes the inverter 104, the controller 309, the motors 141 and 142, fans 150 and 151, a sensor 152, and the switches 326 to 331.

For example, from a physical quantity detected by the sensor 152, when there is no need to rapidly change the indoor temperature, the controller 309 connects the first motor 141 and second motor 142 in series and operates the fans 150 and 151 at extremely low speed. This can improve the energy efficiency and reduce the noise of the fans 150 and 151.

On the other hand, from the physical quantity detected by the sensor 152, when there is a need to rapidly change the indoor temperature, the controller 309 connects the first motor 141 and second motor 142 in parallel and operates the fans 150 and 151 at high speed. Thereby, the indoor temperature can be adjusted more quickly.

By controlling the switches 326 to 331, the controller 309 places the multiple motors 141 and 142 in the parallel connection when operating the multiple motors 141 and 142 at a rotational frequency not lower than a predetermined rotational frequency, and places the multiple motors 141 and 142 in the series connection when operating the multiple motors 141 and 142 at a rotational frequency lower than the predetermined rotational frequency.

When operating the multiple motors 141 and 142 at a minimum rotational frequency in the air conditioner 300, the controller 309 places the multiple motors 141 and 142 in the series connection by controlling the switches 326 to 331. In the series connection, it is possible to operate the multiple motors 141 and 142 at a rotational frequency lower than a minimum rotational frequency at which they can be rotated for a predetermined time period in the parallel connection. The predetermined time period is a certain time period having a certain amount of length, excluding time periods, such as a time of starting or stopping operation of the motors, in which the rotational frequencies of the motors 141 and 142 are temporarily low. Thus, the predetermined time period may be defined to have an arbitrary length that can exclude instantaneous time periods.

The switches 326 to 331 function as a switching unit that switches between the series connection in which the multiple motors 141 and 142 are connected in series to the output side of the inverter 104 and the parallel connection in which the multiple motors 141 and 142 are connected in parallel to the output side of the inverter 104.

In the above-described first to third embodiments, it is possible to further apply a high-frequency wave superposition method that applies a high-frequency voltage to motor(s) and uses a detection current due thereto to estimate the position(s) of rotor(s) of the motor(s). In this case, the rotational frequency of the motors can be further decreased.

In the above-described air conditioners 100 to 300 according to the first to third embodiments, description has been made by taking the fans 150 and 151 as an example of a moving unit that receives power from the motors 141 and 142 to be driven. However, the air conditioners 100 to 300 according to the first to third embodiments are not limited to such an example. For example, the air conditioners 100 to 300 according to the first to third embodiments may include compressors (not illustrated) as a moving unit that receives power from the motors 141 and 142 to be driven. The compressors are devices that compress refrigerant used in the air conditioner.

In the above-described first to third embodiments, the two motors 141 and 142 are connected in series. However, the first to third embodiments are not limited to the case of the two motors 141 and 142, and three or more motors may be connected. In the third embodiment, when three or more motors are connected, it is preferable that in the parallel connection, the number of one or more motors connected in each of multiple branched paths be equal.

1. An air conditioner comprising:
a single inverter to generate a three-phase alternating-current voltage from a direct-current voltage;
n motors connected in series to an output side of the inverter to generate power, n being an integer not less than 2;
a moving unit to receive the power to be driven; and
a controller to perform sensorless control on a basis of an induced voltage caused by the n motors.

2. The air conditioner of claim 1, further comprising a sensor to detect a physical quantity,
wherein when the physical quantity is within a predetermined range, the controller operates the n motors at low speed by controlling the inverter.

3. The air conditioner of claim 2, wherein the physical quantity is at least one of an amount of human activity, an indoor temperature, and an outdoor temperature.

4. The air conditioner of claim 2, wherein in the low-speed operation, the controller operates the n motors at a rotational frequency lower than a minimum rotational frequency that is a lowest rotational frequency at which one of the n motors can be rotated for a predetermined time period.

5. The air conditioner of claim 2, wherein in the low-speed operation, the controller operates the n motors at a rotational frequency lower than one tenth of a maximum rotational frequency of one of the n motors and not lower than one (10×n)th of the maximum rotational frequency.

6. An air conditioner comprising:
a single inverter to generate a three-phase alternating-current voltage from a direct-current voltage;
two motors to receive the three-phase alternating-current voltage to generate power;
a switching unit to switch between a multiple connection in which the two motors are connected in series to an output side of the inverter and a single connection in which only one of the two motors is connected to the output side of the inverter;
a moving unit to receive the power to be driven; and
a controller to perform sensorless control on a basis of an induced voltage caused by the two motors in the multiple connection and on a basis of an induced voltage caused by the one motor in the single connection.

7. The air conditioner of claim 6, wherein when another of the two motors is not energized in the multiple connection, the switching unit switches from the multiple connection to the single connection.

8. An air conditioner comprising:
a single inverter to generate a three-phase alternating-current voltage from a direct-current voltage;
n motors to receive the three-phase alternating-current voltage to generate power, n being an integer not less than 2;
a switching unit to switch between a series connection in which the n motors are connected in series to an output side of the inverter and a parallel connection in which the n motors are connected in parallel to the output side of the inverter;
a moving unit to receive the power to be driven; and
a controller to perform sensorless control on a basis of an induced voltage caused by the n motors.

9. The air conditioner of claim 8, wherein the switching unit places the n motors in the parallel connection when the n motors are operated at a rotational frequency not lower than a predetermined rotational frequency, and places the n motors in the series connection when the n motors are operated at a rotational frequency lower than the predetermined rotational frequency.

10. The air conditioner of claim 8, wherein the switching unit places the n motors in the series connection when the n motors are operated at a minimum rotational frequency.

11. The air conditioner of claim 8, wherein in the parallel connection, the n motors are arranged in a plurality of branched paths so that a number of one or more motors connected in each of the plurality of branched paths is equal.

12. The air conditioner of claim 8, wherein in the series connection, the controller operates the n motors at a rotational frequency lower than a minimum rotational frequency that is a lowest rotational frequency at which one of the n motors can be rotated for a predetermined time period in the parallel connection.
